(19) United States
(12) Patent Application Publication
(10) Pub. No.: US 2017/0127626 A1
(43) Pub. Date: May 11, 2017

(54) AUTOMATIC TIMED-RELEASE WATER-SUPPLYING FLOWERPOT

(71) Applicant: Xiaopeng Wang, Kenmore, WA (US)

(72) Inventor: Xiaopeng Wang, Kenmore, WA (US)

(21) Appl. No.: 14/937,561

(22) Filed: Nov. 10, 2015

(51) Int. Cl. A01G 27/06; A01G 27/00; A01G 9/02

(52) U.S. Cl. CPC A01G 27/06; A01G 9/02; A01G 27/008

(57) ABSTRACT

The automatic timed-release water-supplying flowerpot includes an inner container supported in an upper portion of the interior space of an outer container. Water-absorbent ropes are inserted through inlet water holes cut through the bottom wall of the inner container to absorb water from the lower portion of the interior space of the outer container and carry it to the soil and plant in the inner container. A water-refilling opening is formed between a recessed portion of the side wall of the inner container and the side wall of the outer container. The flowerpot is provided with a filtering tray or a hinged cover over the water-refilling opening to block stuffs other than water from entering the interior space of the outer container. The inner container is supported in the outer container by a horizontally extended rim or by one or more supporting legs.

### BACKGROUND OF THE INVENTION

Field of the Invention

The present invention relates to flowerpots and more particularly to a flowerpot that is adapted for automatically supplying water to the plant therein over a period of time.

Description of the Related Art

In ordinary homes, flowers and small plants are mostly grown in pots or trays, which are often kept indoors. In other words, flowerpots are the main means for growing flowers or small plants at home. However, traditional flowerpots are deficient in many aspects. For example, in order to assure a proper amount of water for the growth of the plant in a flowerpot, one or more holes are normally provided at the bottom of the flowerpot to let out of excess water. But the water thus flowing out of the flowerpot will pollute or mess up the room in which the flowerpot is kept. On the other hand, if flowerpots are left unattended over a period of time, for instance when the homeowners are traveling, water in the flowerpots will dry up, thus causing the plants therein to die out due to lack of water. An alternative is to continuously pump water into the flowerpot and drain water out through a pipe, with or without recycling the water. However, such a flowerpot system would clearly be inconvenient for most homes and wasteful on both water and the electrical energy needed.

Therefore, a flowerpot capable for supplying water to the soil and plant therein without the drawbacks mentioned above is needed.

### BRIEF SUMMARY OF THE INVENTION

A flowerpot without the above-mentioned drawbacks of the traditional flowerpot according to this application is capable of gradually and continuously supplying water to the plant growing therein over an extended period of time for each refill of water to the flowerpot.

Specifically, the flowerpot includes an inner container supported in a top inner space of an outer container by a supporting means, thus forming a water storage space in the outer container between the outer walls of the inner container and the inner bottom wall of the outer container. The outer side wall of the inner container includes a recessed or concave portion extending from the top to the bottom of the side wall, thus forming an opening between the recessed or concave portion of the inner container and the inner side wall of the outer container so that water can be refilled through the opening to the water storage space below. In this application, the term “recessed” is meant to be broader in scope than the term “concave”. Specifically, the recessed is not necessarily “curved”, as implied by the term “concave”.

In order to prevent leaves, flower petals or dirt from entering the water storage space, the flowerpot according to the application may be fitted with a hinged cap over the water-refilling opening. Normally kept closed, the hinged cap is opened only when water is being refilled. Alternatively, a filtering tray with through holes for water to pass through may be disposed at the opening instead of or in addition to the hinged cap.

The bottom wall of the inner container is provided with a number of inlet water holes, through which are inserted elongated pieces or cords of water-absorbent substance, such as ropes or cloth pieces. The pieces or cords of water-absorbent substance extend from above the bottom wall of the inner container down to the inner bottom wall of the outer container for absorbing water from the water storage space up through the inlet water holes to supply water to the soil and the plant contained in the inner container. Thus, a gradual and continuous steady supply of water to the plant over an extended period of time can be achieved.

The inner container has a horizontally extended rim around a top periphery thereof. The inner container can be supported on the outer container by placing the horizontally extended rim directly on top of the side walls of the outer container. Alternatively, a supporting structure including a number of telescopic (length-adjustable) supporting legs disposed on the inner bottom wall of the outer container may be used to support the inner container. With the supporting structure, the inner container need not fit the size of the outer container and therefore can be used with many different sizes of the outer containers. To secure the supporting legs, the outer bottom wall of the inner container is provided with a number of connecting holes with closed upper ends to respectively receive the upper ends of the supporting legs. Preferably, the inlet water holes of the inner container are evenly and symmetrically disposed near the connecting holes for the supporting legs. In one embodiment, each of the connecting holes is formed inside an upwards-extending protrusion from the bottom wall of the inner container. Various length-adjusting means of the supporting legs are widely known in the prior art. Here it suffices to say that each telescopic leg includes an inner rod and an outer tube enclosing at least a portion of the inner rod, wherein the inner rod can be moved back and forth relative to the outer tube and be fixed at various positions.

Furthermore, the automatic water-supplying flowerpot of the application may include a water level indicator in the form of a transparent tube extending from the bottom of the outer container and upwards along the outer side wall of the outer container.

### BRIEF DESCRIPTION OF THE DRAWINGS

Preferred embodiments of the automatic water-supplying flowerpot of the present invention will be described in conjunction with the following figures. Note that the drawings are for the purpose of illustrating embodiments of the invention, not to unduly limit the scope of the claimed flowerpot.

FIG. 1 is a perspective outside view of the automatic water-supplying flowerpot according to a preferred embodiment of the present invention.

FIG. 2 illustrates the outer container of the flowerpot according to the present application with a water level indicator extending from the bottom of the outer container.

FIG. 3 illustrates the inner container with the water-refilling opening of the flowerpot according to the present invention.

FIG. 4 illustrates the side wall with a recessed or concave portion and the bottom wall with the inlet water holes and connecting holes of the inner container.

FIG. 5 shows the inner container with a hinged cap over the water-refilling opening.

FIG. 6 shows the supporting structure of the flowerpot of the present application for supporting the inner container in a top inner space of the outer container.

FIG. 7 illustrates an embodiment of the structure of the supporting legs of the flowerpot of the present application.

FIG. 8 illustrates the length-adjusting means of the supporting legs shown in FIG. 7.

FIG. 9 illustrates a second embodiment of the supporting legs of the flowerpot of the present application.

FIG. 10 illustrates the length-adjusting means of the supporting legs shown in FIG. 9.

### DETAILED DESCRIPTION OF THE INVENTION

The present invention will be described in detail below by way of preferred embodiments in conjunction with the accompanying figures.

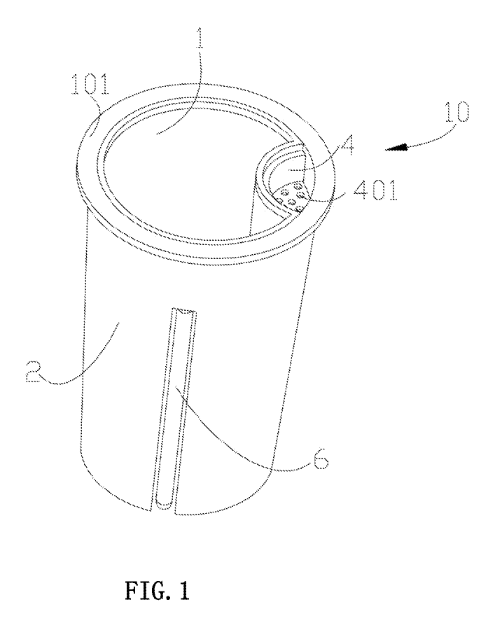

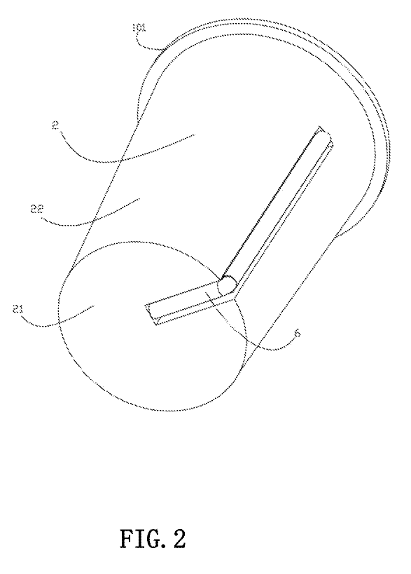

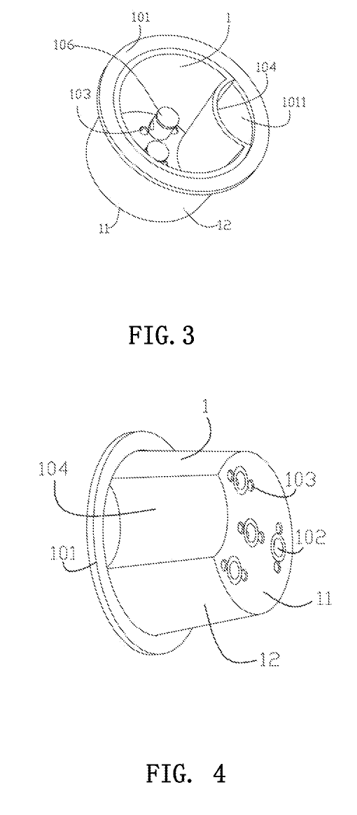

As shown in FIGS. 1-4, the flowerpot 10 for automatically supplying water to the soil and plant contained therein according to the present application includes an inner container 1, an outer container 2, and a supporting means for supporting the inner container 1 in an upper portion of the storage space inside the outer container 2. As illustrated in FIG. 3, the inner container 1 has a bottom wall 11, a side wall 12 connected to the bottom wall 11, and an upwards-opening interior space defined by the bottom wall 11 and the side wall 12. As shown in FIG. 2, the outer container 2 has a bottom wall 21, a side wall 22 connected to the bottom wall 21, and an upwards-opening interior space defined by the bottom wall 21 and the side wall 22.

As shown in FIG. 4 and FIG. 6, a plurality of inlet water holes 103 are formed through the bottom wall 11 of the inner container 1 for respectively receiving and holding a plurality of elongated pieces or cords of water-absorbent substance 3. The water-absorbent pieces or cords 3 extend upwards from the bottom wall 21 of the outer container 2, through the inlet water holes 103, and into the interior space in the inner container 1. The water-absorbent pieces or cords 3 are preferably in the form of ropes or strings.

As shown in FIG. 3 and FIG. 4, the side wall 12 of the inner container 1 has a recessed or concave portion 104. The recessed or concave portion 104 extends over the entire height of the side wall 12 of the inner container 1, such that a water-refilling opening 1011 is formed between the recessed or concave portion 104 and the inner surface of the side wall 22 of the outer container 2.

When the inner container 1 is supported in the upper portion of the interior space of the outer container 2, the bottom wall 11 of the inner container 1 is suspended above the bottom wall 21 of the outer container 2, leaving a water storage space therebetween for storing water.

In using the flowerpot 10 of the present application, water is added through the water-refilling opening 1011 into the water storage space inside the outer container 2; due to capillary action, water is absorbed by the water-absorbent pieces or cords 3 to be brought upwards through the inlet water holes 103 into the interior space of the inner container 1 for the soil and plant stored therein. Because only a limited amount of water is carried upwards by capillary action, the soil and plant will not be flooded by excessive amount of water. To achieve the level of moisture needed, the number of water-absorbent pieces 3 may be adjusted. That way, water may be continuously and gradually provided to the soil and plant in the inner container 1 over a period of time—until water is exhausted in the water storage space of the outer container 2, upon which water may be refilled.

In order to timely alert the low water level in the water storage space in the outer container 2, the outer container 2 is provided with a water level indicator 6, as shown in FIG. 2. The water level indicator 6 is a transparent tube connected to and passing through the bottom wall 21 of the outer container 2 and extending sideways then upwards along the outer side of the side wall 22 of the outer container 2. The bottom wall 21 and the side wall 22 of the outer container 2 may be provided with a positioning groove, as shown in FIG. 2, to receive therein the water level indicator 6. Alternatively, the water level indicator 6 may have the transparent tube connected to the side wall 22 near the bottom wall 21 and extend upwards along the outer side of the side wall 22 of the outer container 2.

As illustrated in FIG. 1 and FIG. 2, the supporting means of the flowerpot 10 of the present application may be embodied in a horizontally extended rim 101 around the top periphery of the side wall 12 of the inner container 1 so that the inner container 1 can be supported when the rim 101 of the inner container 1 is placed directly on top of the side wall 22 of the outer container 2.

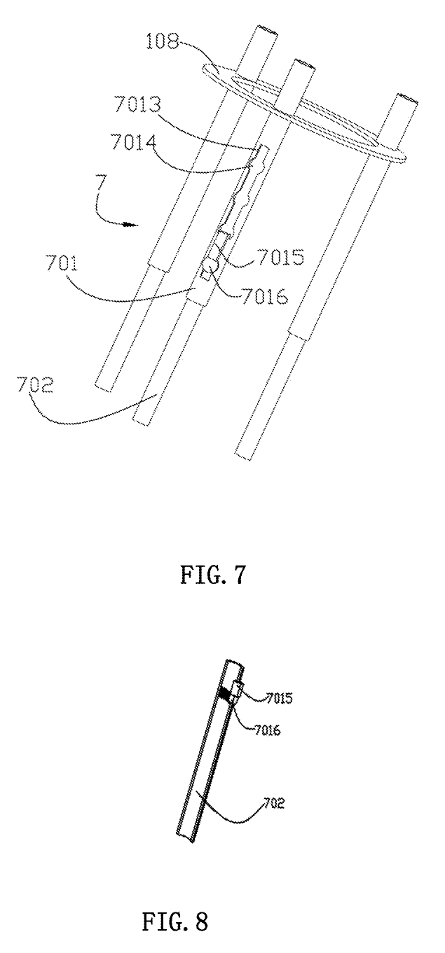

If the rim 101 of the inner container 1 cannot be supported on top of the outer container 2, i.e. when the top periphery of the container 2 is larger than the rim 101 or when the inner container 1 is to be supported at a different elevation, a different supporting means may be used. As shown in FIG. 6 and FIG. 7, the inner container 1 is supported by a support structure 7 having three supporting legs 70. The supporting legs 70 stand on the upper side of the bottom wall 21 of the outer container 2 and extend therefrom to the underside of the bottom wall 11 of the inner container 1. The supporting legs 70 are preferably adjustable in length to allow the inner container 1 to be supported at various heights. Namely, the supporting legs 70 are preferably telescopic legs. Three supporting legs 70 are preferred, as shown in FIG. 6 and FIG. 7, however, the number of supporting legs 70 may be one, two, or even more than 3, depending upon the size of the outer container 2 and other practical factors.

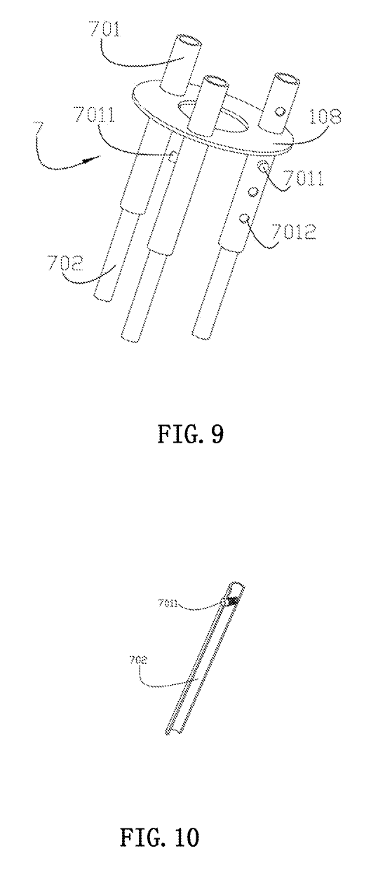

In order to keep the supporting legs 70 in a stable position, the inner container 1 is provided with connecting portions, as shown in FIG. 6, in the form of protrusions 106 extending upwards from the bottom wall 11 of the inner container 1. Each of the protrusions 106 has an internal conduit, which is closed at the upper end, and open at the lower end through the bottom wall 11 of the inner container 1. Namely, a connecting hole 102 is formed inside each protrusion 106, so that the upper end of each of the supporting legs 70 is inserted into one corresponding connecting hole 102 to achieve a stable support for the inner container 1. Preferably, the upper end of the supporting legs 70 have the same dimension as the connecting holes 102. To further fix the supporting legs 70 in proper relative positions, a fixing disc 108 with fixing through holes, the same in number as the supporting legs 70, may be added, as shown in FIG. 7 and FIG. 9. The supporting legs 70 are respectively inserted through the fixing through holes of the fixing disc 108 in order to maintain their relative positions. When the supporting legs 70 are in place to support the inner container 1, the fixing disc 108 will be placed below the bottom wall 11 of the inner container 1.

Referring to FIG. 6 again, it is preferred that for each connecting hole 102 for the supporting leg 70, two through holes 103 be disposed, near the associated protrusion 106 and opposite to each other from the protrusion 106. This way, the two water-absorbent pieces or cords 103 may each be spirally wound around the associated supporting leg 70 for absorbing water and transporting water evenly.

The structure and types of the length-adjusting (telescopic) means of the supporting legs 70 are well known in the prior art. Two types of telescopic legs 70, as illustrated in FIGS. 7-10, will be briefly described here. Each telescopic leg 70 is formed with an outer tube 701 and an inner rod 702. The inner rod 702 is partially enclosed by the outer tube 701 and movable inwards and outwards relative to the outer tube 701. In one embodiment, shown in FIG. 7 and FIG. 8, the outer tube 701 has an elongated sliding slot 7013 along a length of the outer tube 701 and a number of expanded locking holes 7014 spaced from each other along the sliding slot 7013; the inner rod 702 is provided with a slider 7015 connected to a spring-loaded button 7016, whereby the inner rod 702 can be moved back and forth relative to the outer tube 701 by pressing in the spring-loaded button 7016 and slide the button 7016 with the slider 7015 along the sliding slot 7013 of the outer tube 701 until the spring-loaded button 7016 is aligned with and released to be locked at one of the expanded locking holes 7014 corresponding to a desired total height of the telescopic supporting leg 70.

In another embodiment, as shown in FIG. 9 and FIG. 10, the outer tube 702 has a number of locking holes 7012, preferably aligned along a length thereof and spaced from each other, and the inner rod 702 has a spring-loaded button 7011, whereby when the spring-loaded button 7011 of the inner rod may be pushed in to allow the inner rod 702 to be moved back and forth until the button 7011 is aligned with and released to be locked at one of the locking holes 7012, so that the inner rod 702 is fixed in position relative to the outer tube 701.

Furthermore, as shown in FIG. 1, in order to keep unwanted stuffs, such as flower petals, leaves, branches, dirt or other extraneous matter from entering the water storage space in the outer container 2, a filtering tray 4 with a contour corresponding to the opening 1011 and a plurality of small through holes 401 may be disposed across the opening 1011. With the filtering tray 4, only water and stuffs smaller than the through holes 401 may pass through the through holes 401, thus achieving an effective blocking or screening of unwanted stuffs. As shown in FIG. 1, the filtering tray 4 may be connected to the inner side of the side wall 22 of the outer container 2.

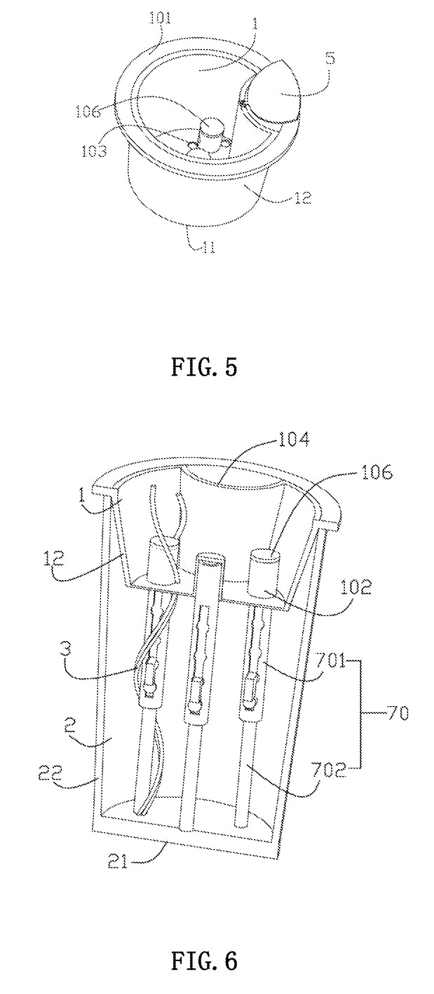

Alternatively, as shown in FIG. 5, a hinged cap 5 of a shape corresponding to the water-refilling opening may be provided at the top end of the recessed or concave portion 104 of the side wall 12 of the inner container 1. The hinged cap 5 may be easily opened and closed. Normally the hinged cap 5 is kept closed; it is opened for water to be refilled. Note that a flowerpot 10 of this application may have the hinged cap 5, the filtering tray 4, or both.

Further, to fix the water-absorbent cords 3 in stable positions, it is preferred that two through holes 103 be provided for each protrusions 102, adjacent to the protrusion 102 and opposite to each other from the protrusion 102. This way, the two water-absorbent cords may each be spirally wound around the associated supporting leg 70 for absorbing water and transporting water evenly.

Although particular embodiments of the present invention have been described in detail for purposes of illustration, various modifications and enhancements may be made without departing from the spirit and scope of the invention. Accordingly, the invention is not to be limited except as by the appended claims.

What is claimed is:

1. A flowerpot for automatically supplying water to soil and plant contained therein over a period of time, the flowerpot comprising:
an inner container for containing soil and plant, the inner container having a bottom wall, a side wall connected to the bottom wall, and an interior space defined by the bottom wall and the side wall, wherein a plurality of inlet water holes are formed through the bottom wall, and the side wall has a recessed portion on an outer side thereof;
an outer container having a bottom wall, a side wall connected to the bottom wall, and an interior space defined by the bottom wall and the side wall;
a supporting means for supporting the inner container in an upper portion of the interior space of the outer container; and
a plurality of elongated pieces of water-absorbent substance respectively passing through the plurality of the inlet water holes of the bottom wall of the inner container, each piece of water-absorbent substance extending from a distance inside the interior space of the inner container and downwards into a lower portion of the interior space of the outer container;
wherein the recessed portion of the inner container and the inner side of the side wall of the outer container together form a water-refilling opening, through which water may be added into the lower portion of the interior space of the outer container,
whereby water is absorbed by the elongated pieces of water-absorbent substance from the lower portion of the interior space of the outer container to be brought upwards into the interior space of the inner container for consumption by the soil and plant contained therein.

2. The flowerpot as claimed in claim 1, wherein the supporting means comprises a rim horizontally extending from a top periphery of the side wall of the inner container, whereby the inner container is supported when the rim is placed directly on top of the side wall of the outer container.

3. The flowerpot as claimed in claim 1, wherein the supporting means comprises at least one supporting leg standing on the bottom wall of the outer container and having an upper end interacting with the bottom wall of the inner container.

4. The flowerpot as claimed in claim 3, wherein the at least one supporting leg is each a telescopic leg.

5. The flowerpot as claimed in claim 3, wherein the at least one supporting leg includes three supporting legs.

6. The flowerpot as claimed in claim 5, further comprising a fixing disc with three fixing through holes, wherein the three supporting legs are inserted through the three fixing through holes of the fixing disc to be fixed in relative position.

7. The flowerpot as claimed in claim 3, wherein the inner container has at least one protrusion extending upwards from the bottom wall thereof, wherein the protrusion has an internal conduit that is closed at an upper end and open at a lower end to form a connecting hole through the bottom wall of the inner container, whereby the upper end of the at least one supporting leg is respectively inserted through the connecting hole inside the at least one protrusion.

8. The flowerpot as claimed in claim 1, further comprising a filtering tray fitted across the water-refilling opening, wherein a plurality of through holes are formed at a bottom wall of the filtering tray for allowing water to pass through the water-refilling opening while blocking leaves and other extraneous materials.

9. The flowerpot as claimed in claim 8, wherein the filtering tray is connected to the inner side of the side wall of the outer container.

10. The flowerpot as claimed in claim 1, further comprising a hinged cap for covering up the water-refilling opening, wherein the hinged cap may be opened to allow water to be added through the water-refilling opening.

11. The flowerpot as claimed in claim 8, further comprising a hinged cap for covering up the water-refilling opening, wherein the hinged cap may be opened to allow water to be added through the water-refilling opening.

12. The flowerpot as claimed in claim 1, further comprising a transparent tube in water communication with the lower portion of the interior space of the outer container, wherein the transparent tube extends from under the bottom wall of the outer container and extends sideways then upwards along an outer side of the side wall of the outer container for indicating water level in the lower portion of the interior space of the outer container.

13. The flowerpot as claimed in claim 12, wherein a positioning groove is formed on an underside of the bottom wall and the outer side of the side wall of the outer container for receiving and positioning the transparent tube.

14. The flowerpot as claimed in claim 4, wherein each telescopic leg includes an outer tube and an inner rod partially enclosed by the outer tube, wherein the outer tube has a plurality of button locking holes spaced apart along a length of the outer tube, and the inner rod has a spring-loaded button, wherein when the spring-loaded button is pressed in, the inner tube is movable back and forth relative to the outer tube, and when the inner rod is moved relative to the outer tube such that the spring-loaded button is aligned with and released through any of the button locking holes of the outer tube, the inner rod is fixed in position with the outer tube.

15. The flowerpot as claimed in claim 14, further comprising an elongated sliding slot on the outer tube connecting the button locking holes and having a width narrower than the button locking holes, and a slider connected to the spring-loaded button on the inner rod, wherein the slider is movable with the button along the sliding slot.

16. The flowerpot as claimed in claim 1, wherein each of the elongated pieces of water-absorbent substance is in the form of ropes or strings.

17. The flowerpot as claimed in claim 1, wherein two of the inlet water holes of the bottom wall of the inner container are positioned adjacent to each of the at least one protrusion, one on each of two opposite sides thereof.
